(19) United States
(12) Patent Application Publication
(10) Pub. No.: US 2006/0282395 A1
(43) Pub. Date: Dec. 14, 2006

(54) Methods for using a mobile communications device in consumer, medical and law enforcement transactions

(76) Inventor: Joe Leibowitz, Falls Church, VA (US)

Correspondence Address: JOE LEIBOWITZ, 2028 PEACH ORCHARD DRIVE, APARTMENT # 13, FALLS CHURCH, VA, 22043, US

(21) Appl. No.: 10/908,862

(22) Filed: May 30, 2005

(51) Int. Cl. G06Q 99/00; H04K 1/00; H04L 9/00

(52) U.S. Cl. 705/67

(57) ABSTRACT

A system and methods to integrate, secure and simplify transaction conducted by means of a mobile electronic communications device such as a cell phone or smartphone, combining biometric identification, computer software applications resident in the device's memory, PAN (personal area network) and data storage and transmission means, such system and methods being useful in credit or debit card transactions, automated transmission and retrieval of private medical information and the retrieval of law enforcement data, among other possible uses, purposes and applications.

### FIELD OF THE INVENTION

The present invention addresses the field of portable communications devices and methods of using such devices, especially the technological issues of identity theft, convenience of use, security of data, cost of use, privacy of medical data and local access to law enforcement data.

### BACKGROUND OF THE INVENTION

Today, the use of credit, debit and other cards is nearly universal, with the card used serving to identify the buyer's account and also as a partial identification of the holder of the card. The security of electronic transactions effected with such cards is a public issue of vital concern. Identity theft has grown to alarming proportions in recent years, including the wholesale theft of hundreds of thousands of individual profiles by a single breach of security. Individuals need more secure means to establish credit and other accounts as well as more secure means to engage in transactions over these accounts. These means should not be so costly, inconvenient or invasive of privacy as to make them unsuitable for widespread use by all participants in the American economy or in foreign economies.

Generally, a person must possess a credit card or other similar physical container, such as a magnetic ink encoded paper check, smart card, magnetic swipe card or a personal computer programmed with account data, such physical container being programmed or encoded with data unique to the container's user. In contrast, the invention disclosed herein requires users to carry no special containers separate from the cell phone, or similar portable device, that the user will be carrying in any case for communications purposes.

Credit cards are easily misused criminally. For one thing, a thief who obtains the card may simply use it until its limit is reached or the user deactivates the card. Another form of misuse is counterfeiting of such cards. Fraudulent cards are created by sophisticated rings of criminals who acquire a user's account number and produce a passable imitation or counterfeit of the user's actual card. Yet another criminal method is unauthorized use by a retailer or his agent who may obtain the user's account number and fraudulently make purchases or obtain cash on the account. Estimates of losses due to these types of crimes exceed three billion dollars per year.

There are also many cases of fraud by users. Having made purchases themselves or received cash, the user in these cases will claim that the card had been lost or stolen before the purchases in question were made, in effect absolving himself fraudulently of responsibility for the purchases.

A potential solution to these problems of fraud is use of a smartcard that includes biometric means of identification. In this approach, pre-registered biometric data, such as a fingerprint, is used as a test against which the card holder's print is authenticated prior to authorizing a transaction. If the stored biometric matches the holder's on-site biometric, authorization is made.

Several forms of container-based biometric identification systems are found in the prior art, including use of smart cards, magnetic swipe cards, or paper checks with biometric sampling. Drawbacks of these systems disclosed in the prior art include storage of complete biometric data in the container and capable of reproduction, posing a risk because the authorization procedures are not separated from the locally used devices and applications or because the user's financial data is stored in the container itself. Prior art of this nature is disclosed, for example, in U.S. Pat. No. 4,821,118 (Lafreniere); U.S. Pat. No. 4,993,068 (Piosenka et al.); U.S. Pat. No. 4,995,086 (Lilley et al.); U.S. Pat. No. 5,054,089 (Uchida et al.); U.S. Pat. No. 5,095,194 (Barbanell); U.S. Pat. No. 5,109,427 (Yang); U.S. Pat. No. 5,109,428 (Igaki et al.); U.S. Pat. No. 5,144,680 (Kobayashi et al.); U.S. Pat. No. 5,146,102 (Higuchi et al.); U.S. Pat. No. 5,180,901 (Hiramatsu); U.S. Pat. No. 5,210,588 (Lee); U.S. Pat. No. 5,210,797 (Usui et al.); U.S. Pat. No. 5,222,152 (Fishbine et al.); U.S. Pat. No. 5,230,025 (Fishbine et al.); U.S. Pat. No. 5,241,606 (Horie); U.S. Pat. No. 5,265,162 (Bush et al.); U.S. Pat. No. 5,321,242 (Heath, Jr.); U.S. Pat. No. 5,325,442 (Knapp); and U.S. Pat. No. 5,351,303 (Willmore).

All of the above patents comprise systems whereby consumers employ containers of various kinds, including credit cards and smart cards, in contrast to the invention described herein wherein a cell phone or similar communications device is enabled to combine partial biometric data, to accept and understand sequential entry of biometric data and to initialize, authorize and confirm transactions based on these data inputs. The present invention also particularly addresses the cost and convenience questions raised by the described prior art, which generally requires increasingly complex and expensive containers, and associated equipment, in order to reduce fraud risks.

For example, to convert to a smartcard system, which will involve cards costing up to twice as much as the current form of credit card as well as the purchase of smartcard readers and biometric-reading equipment, a deployment expense of many billions of dollars would be incurred to provide smartcard services to some 130 million credit card owners and 5 million retail or retail-like outlets. The deployment cost alone might exceed the current annual rate of losses caused by the frauds that smartcard use addresses.

To overcome the unbalanced financial equation of deploying a smartcard solution, there has been an effort to multiply the potential uses of the smartcard in order to spread the cost of initial deployment. Among the proposed additional uses of the smartcard are storage of store phone numbers, frequent flyer miles, retail coupons, users' transactional history, electronic cash for express highway toll stations and the card holder's identity and medical data.

Such efforts to augment smartcard functionality pose the additional risk to consumers that loss of such a centralized set of functionalities would result in very significant inconvenience and possible financial loss where the card contains an electronic store of cash. In contrast, by the terms of the present invention, loss of the cell phone would be easily overcome by a trip back to the cell phone service provider's office to report the loss and obtain a new cell phone into which all the existing data stored in the lost device could be automatically re-input without much inconvenience. And no risk of financial loss would be posed since any person who attempted to use the device would not be able to swipe the true owner's fingerprint.

US Patent Application 20050027543, Labrou, Yannis et al. (‘Labrou’) discloses methods for purchasing goods and services, employing mobile consumer devices, such as a cell phone, connected wirelessly to a network or networks and wherein third-party verification means are deployed to receive signals from the cell phone and verify identity for the purpose of authorizing and confirming transactions. Separately, merchant devices similarly identify themselves to the third party as part of the transaction-authorizing and -confirming process. The disclosed third party identifying service in turn is networked to the financial transaction processor concerned in the user-retailer transaction. Also disclosed is use of biometric identification means such as fingerprints in connection with the user's networked connection to the third party. Labrou teaches away from the key disclosures of the current invention: (1) no method is provided to bifurcate the storage of biometric identifying data either on the consumer side or the merchant side, (2) separate merchant-side apparatus is required to be purchased and used for the methods therein disclosed to function properly, (3) Labrou establishes an infrastructure wherein a third-party actor must be organized in order to operate a database and software applications assigned the tasks of verifying identities, authorizing transactions, confirming transactions and transmitting transactions for payment to financial institutions, (4) no method is disclosed whereby, as in the present invention, both the consumer and the retailer use the cell phone device alone as the principal transactional device, (5) Labroudiscloses no specified registration process for cell phone users wherein, according to the disclosures of the present invention, persons wishing to participate in phone-based credit transactions may conveniently purchase the means to do so and simultaneously register accounts and establish biometric identity (6) Labrou similarly does not disclose a method wherein retailers and other second parties who wish to engage in transactions with consumers by means of a cell phone will engage in a registration process at the office of a local cell phone services provider, thereby obtaining a retailer's cell phone device capable of optionally authorizing the originating retail agent to create subagent accounts without further involvement of the cell phone services provider and (7) Labrou discloses no methods useful in the handling of private medical data or in the handling of local law enforcement data.

The essential distinguishing grounds of the present invention are comprised in the seamless, integrated, secured use of one common device protected by bifurcated biometric identification means and operated by sequential entry of biometric data and the compatibility of such use with all current networks, financial systems and databases. The end result is highly enhanced security, great convenience, low cost and the possibility of universal adoption and use. In addition, the present invention discloses medical uses and applications that are based on the essence of the system and methods disclosed in connection with credit and debit transactions.

It is an essential aspect of the present invention that identifying data such as the digitized fingerprint of a user and the social security number of the user be bifurcated, with part stored on the user's device and the other, complementary part stored in the database of a retailer, financial transaction processor or other second party. By this method of the invention, identity theft becomes virtually impossible because the theft of data from a common central database, a type of crime that is increasingly more common and alarming, would not yield a complete social security number or fingerprint. Without complete data, hackers and their associates would not be able to establish identities to use for fraudulent purposes. In this aspect of the invention, it is required that the user's device be integrated into the transactional system since that is where the complementary parts of the identifying data reside. For this reason, among others, the present invention is distinguished over so-called ‘tokenless’ authorization systems that permit the user to swipe a fingerprint onto a device and thereby initiate both an identification process and the desired transaction.

US Patent Application 20020019811, Lapsley et al., teaches such a biometric-based tokenless authorization system wherein the consumer and merchant use an access device, which may be a cell phone, to communicate with each other, including the exchange of biometric data of the consumer and the confirmation of transactions. Lapsley teaches away from the present invention because: (1) none of the user's personal data is stored in the device whereas it is an essential security feature of the present invention that partial biometric and social security number data be stored in the user's device (2) the ‘comparator’ engine in Lapsley compares the user's swiped fingerprint with the complete, centrally-stored sample whereas the present invention requires for security purposes that the comparison of fingerprint data and social security number data be done on the user's own private device, (3) the present invention comprises a simple, convenient and low-cost method for registering a user's identity and accounts at the office of a cell phone service provider's office where Lapsley is not clear on how or where users will be first registered, there being no simple administrative solution to this problem proposed in that patent application, (4) Lapsley does not contemplate that the retailer or other second party will also enter biometric data into the access device described therein for identity and transactional purposes whereas the present invention requires that a retail agent engage with the user in swiping a fingerprint and entering data and confirmations onto the cell phone device, (5) Lapsley proposes no common administrative solution to the problem of registering retailers and other second parties with the identification/authorization processes described in that invention whereas the present invention claims a solution to the problem of registration for second parties that is parallel to the solution for registration of users, (6) as Lapsley is being practiced currently, (http://www.csmonitor.com/2004/0426/p13s01-wmgn.html) a third-party database and application is used to store identifying data and to compare biometrics for identification purposes, which is naturally the result of that invention's teaching away from consolidating functions within the user's cell phone as claimed in the present invention, (7) Lapsley makes no mention of using the methods it claims in the storage, inputting and transmission of medical data nor does it mention any use in connection with law enforcement issues such as traffic stops, whereas the present invention claims that the methods disclosed will be amenable to such uses, (8) Lapsley, at least as currently practiced, involves investment in access devices by, for example, supermarkets that use the methods described in that invention, whereas it is a main aspect of the present invention that no new equipment need be purchased by any party to the transactions described beyond the basic cell phone that users would in any event purchase for other uses.

The present invention addresses the need for a transactional system that will prevent fraud and that is convenient and low-cost. The present inventions discloses methods wherein biometric identification systems and processes perform authorization and confirmation of transactions without the use of containers such as smartcards or credit cards and without investment in new equipment by retailers and other similarly situated persons and organizations that transact business with consumers. The present invention makes use of existing computer network capabilities, existing database and software applications and existing cell phone system capacities.

By splitting or bifurcating biometric data like digitized fingerprint data and social security number, the present invention avoids the risks posed by devices and systems of the prior art, wherein an entire copy of, for example, a user's fingerprint is stored in the mobile device or container. Or, in the alternative, wherein a complete copy of the user's identifying biometric data and social security number are stored in a centralized database that may, if a security breach should occur, be discovered and used by parties intent on fraud. By the terms of this invention, the cell phone device stores only the one part of the identifying data with the other, complementary part residing in a centralized database. The cell phone is programmed to combine the stored half and the remote half and then to compare the combined result with the swipe then being made across the cell phone. The end result is a highly secure methodology for storing and using sensitive identification data, somewhat comparable in effectiveness to the public key infrastructure (PKI) now widely used for convenient sending and receiving of encrypted messages.

The present invention also provides a system and methods for registering retail companies, their agents, and other similarly situated persons who will engage in transactions with a cell phone owner. By virtue of this aspect of the invention, such second parties will need to invest in no new equipment to participate in the proposed system, except insofar as their current computers and like devices do not include technological features that have been available for the last five years.

The present invention also is compatible with all existing transactional systems relating to credit cards, debit cards and other such containers.

The methods disclosed in this invention for the bifurcation of fingerprint and other biometric data work easily for cell phone owners, where the one part of the identifying data is stored in the user's device. For retail agents and their subagents, a different problem is posed when such second parties swipe their fingerprint onto the user's cell phone: the user's device cannot store a part of the retailer's fingerprint in advance of the transaction. For bifurcation on the second party side to work, it is necessary to wirelessly connect the user's cell phone device to an in-store PC or laptop capable of storing a partial biometric identification. Optional registration methods will allow retail agents so equipped to store partial biometric identification data on the centralized database while retail agents without such in-store means will store an entire copy of their biometric data on a central database.

With respect to the problems of ready access to private medical data, there is a need for some means whereby essential medical data about an individual can be readily inputted and extracted from a system by both individuals and medical service providers. Security of the data and possible misuses are constant problems. The means needed to address this need should be convenient, low-cost and not invasive of privacy.

By claim 8, it is another aspect of the present invention that the methods claimed and described above in connection with credit/debit transactions are adaptable to being used in connection with law enforcement. It is envisioned that law enforcement entities such as a city police department, could register a cell phone device by the terms of claim 6, including the method of agent-subagent registration of said claim. In addition to being wirelessly connected to financial transaction and medical information applications and databases, the user's cell phone could optionally be connected to law enforcement databases and applications. When, for example, a device owner is subjected to a traffic or other law enforcement stop, a sequence of fingerprint swipes by the user and by the law enforcement officer could activate the connection and download for display material information about the user, such as her license data, car registration and any other relevant information. The advantage to cell phone owners who enable such law enforcement transactions is that traffic stops would thereby be made quicker and less inconvenient. Instead of the law enforcement officer's having to gather data manually from the user and then return to his patrol car to access a laptop for further processing, the entire transaction could be initiated and completed by the side of the user's car. As well, in the case of emergency roadside assistance involving an unconscious or otherwise disabled user following an accident or sudden illness, the law enforcement officer could be optionally enabled to activate either or both the medical and law enforcement functions of the cell phone to enable more effective emergency assistance.

Further to this aspect of the invention, the efficiency and convenience of ordinary traffic stops could be enhanced by adapting the present methods to the issuance of traffic summonses. That is, where a user's cell phone device is enabled to connect to law enforcement databases and where a police officer is issuing a citation to the said user, it could optionally be made a part of the present system to permit the officer to enter the summons data into the cell phone, or into a small-area network connected device of his own that links by IR or Bluetooth to the user's device. A paperless summons could thereby be created, including optionally transmission to the user's home computer or, indeed, her cell phone, of a summary of the citation and court date or other relevant information.

### SUMMARY OF THE INVENTION

By the terms of the present invention, a consumer will be able to purchase a cell phone equipped with fingerprint identification means and with a specially configured internal processor.

By one aspect of the invention, a cooperating cell phone service provider, together with a credit providing company such as a bank or retailer, will employ computer applications that connect a consumer's cell phone directly to the databanks of the financing company or its financial transaction processing affiliate for the purpose of authenticating the cell phone owner's identity via fingerprint comparison, or other biometrics, and by social security number. The methods of this invention will then allow the authorized user to employ his cell phone to transact credit, debit or other transactions at retail stores or other locations.

At the cell phone service provider's location, the user will first establish his or her identity via documentary means, choose a credit/debit service provider or providers and do the initial fingerprint entry and testing. The initial testing should include confirmation that the cell phone recognizes the fingerprint of the user, that the connection to the selected credit provider can be effected and that the user's credit, debit or other account is properly created. The cell phone service provider will assist the cell phone user to register any existing credit card accounts by means of the credit card reader already in place in such establishment or the account may be switched to cell phone enabled status by manual means such as by-hand entry of the necessary data into the cell phone device.

Having established identity, connectivity and account status at the office of the cell phone service provider, the owner of the cell phone or other similar device will be able to forego use of any physical card and instead use his or her cell phone to conduct business with any retailer or other second party that has likewise registered under the methods and system embodied in this invention.

Prior art teaches the means to embody fingerprint identification technology into cell phones.(http://www.atmel.com/dyn/resources/prod_documents/5380A.pdf ) Prior art likewise embodies programming cell phones and similar devices to enable Internet and other network connections for the purpose of transmitting and receiving data.

Prior art also teaches the use of infrared and other short-range wireless connections between cell phones and other electronic devices such as PCs, laptops and other similar machines.

By claims 3 and 4 of the present invention, fingerprint data and a social security number will be maintained in a centralized database but not in complete form. It is a key aspect of the present invention to maintain on the user's cell phone device the one part of the data while maintaining the other, complementary part on the centralized database. The cell phone device software will be able to download the centrally stored one part and the device-stored other part, combine these and compare the result with the fingerprint and social security number being input into the cell phone sensor device. This aspect of the invention provides several benefits. For one, even in the case of a security breach into a centralized database of the kind that has been widely publicized in recent years, no prospective abuser of the information in the database would obtain a complete fingerprint or social security number, making it impossible to commit fraud by means of replicating the fingerprint or using the social security number. Second, since this provides a high level of security for transactions, there would be no need to invest in maintaining any separate identification database apart from the existing databases of financial institutions. An expensive centralized database, required for example in Labrou et al., is necessary for security purposes when the identifying data is not subjected to the bifurcation that is claimed as a method in the present invention.

By claim 5 of the invention, the problem of identity theft can be nearly eliminated since the verification step of the initial fingerprinting will discover whether any unauthorized person is using the identity of the true cell phone owner. When the user inputs his initial identity data into the system, including, for example, social security number and birth date, the present invention's identification process will reveal whether an identity thief is also using the same identity data, even if the said thief is using it under a different, fraudulent fingerprint.

By claim 5 of the invention, even in the event that an identity thief were to successfully complete a full initial fingerprint process and acquire a cell phone fraudulently in the name of another person, two elements of the invention would severely limit the damage that the thief could do. First, there would now be a fingerprint record of the perpetrator of the crime, making it far more likely that the thief could be identified and brought to justice, thus inhibiting the successful carrying out of such frauds. Second, the thief would be limited to using one cell phone, since, were he to try to register a second cell phone under a different set of stolen identity information, his or her fingerprint identification would make it impossible to obtain the second phone. As is known in the practice of identity theft, a ring of criminals can only succeed in such projects by using the identities of many persons. A typical ring member might use ten or twenty different identities in order to make the operation profitable. If such criminals were limited, by the use of the fingerprint identification process described herein as one aspect of the invention, to merely one such fake account, much of the profit in the criminal enterprise would be drained away. Even given the worst case scenario, whereby the thief fraudulently obtains a cell phone with someone else's identity, the same thief could never again do so, given that his fingerprint is registered. In fact, the same person could never legitimately obtain even his own, lawful cell phone in view of his or her having registered his fingerprint under a different set of identity data. In essence, by these methods and system, an identity is linked to a single cell phone and to a single fingerprint, contributing to the overall security and efficiency of the present, insecure credit and debit system.

It is contemplated by the terms of this invention that the unique identifying serial number for each cell phone device to be used in connection with the disclosed methods is stored in the memory of the device and will be used in the transactional phase wherein the user's information is transmitted to initiate and obtain authorization for a transaction. The linkage of unique cell phone ID to unique fingerprint ID and unique social security number doubly or triply secures and integrates transactions that will be executed under the methods and system disclosed in the present invention. Flexibility in the invention is provided by allowing users to change cell phone devices under the basic registration process described above with the added procedure of disabling the prior device, constantly maintaining unique fingerprint/unique cell phone linkage.

Further to the prevention of crime and the apprehension of identity thieves, the built-in locator means of every cell phone can be used to follow the movements of the criminal, greatly increasing the chances of apprehension. Cell phones maintain continuous awareness of their location in a network of cell phone towers by automatically paging to discover the strongest local signal. Under the present system of credit cards and the like, identity thieves can move around freely, going from state to state, without concern that the cards themselves have any locator means to establish their whereabouts. In contrast, a thief would be aware that the cell phone is broadcasting his or her location at all times, making it far easier to capture the criminal. According to proposed standards for the cell phone industry, it is contemplated that within a few years, locator technology resident in cell phone devices should be able to pinpoint a user's location to within 125 meters. http://www.fcc.gov/911/enhanced/releases/motaccuracy.pdf

To the same purpose of reducing or eliminating fraud, the present system and methods envision that an effective time limit will be programmed into the cell phone device such that, once a user does a first swipe of his fingerprint, the subsequent and last user swipe that authorizes the transaction must occur within some reasonable period of time. This aspect of the present invention will avoid the risk posed by a user's swiping the cell phone and unintentionally leaving the device in a semi-authorizing mode.

Also by claim 1 of the present invention, a vast reduction in the costs of deployment and use is achieved by eliminating the need for any special reading devices. Retail stores, for example, would not need to invest in any new equipment to read the cell phone or enter transactions. One of the great obstacles facing universal adoption of smart cards or prior-art transaction-enabled cell phones is the cost to deploy equipment that can read the card or phone. Instead, by claim 1 and claim 2, a two-party system is programmed into the processor of the cell phone and the corresponding databases and software that execute the methods of the invention.

By one aspect of the invention, and similar to the registration process described above for individual cell phone owners, a retail company will be able to register itself at the same cell phone service provider sites used by individuals. Based on adequate documentation authorizing the registration, documentation which may vary depending on, for example, whether the prospective retail registrant is a store owned by one person or a chain of retail stores, the retailer's designated registration agent will undergo essentially the same process as an ordinary cell phone user, establishing a fingerprint file together with identity information and then testing and confirming the good operation of the identification process and account status. The retailer's agent would then be issued a cell phone that is virtually the same as the one issued to any individual user.

Further to this system for registering retail agents, any designated agent's cell phone could be specially programmed to permit that same agent to create subagent accounts at any location. That is, the designated principal retail agent would optionally be given authorization to use his or her cell phone to set up identity accounts for sales clerks and like personnel without having to return to the cell phone service provider site. To this purpose, the retail agent's cell phone would be programmed to accept and store partial fingerprints of both the designated agent and those subagents whom he or she registers on that cell phone. The net effect of this system of creating and administering accounts is a great reduction in the cost of operating the system and methods described in this invention. There would be no special equipment required beyond the registered retail agent's cell phone nor would frequent trips to the cell phone service provider's office be required.

By one aspect of this invention, the registration of any designated retail agent or his subagents would be optionally time-limited such that upon expiration of the specified registration period, if any, the registrant would be required to re-register his status and account. In the case of the designated retail agent, she would be required to re-visit the cell phone service provider office, present appropriate documentation and confirm identity and status. And subagents would optionally also be subject to such confirmation. For subagents such process would be carried out by the designated agent who originally registered the subagent or by the designated agent's successor in this power.

By another aspect of this invention, retail companies, and others using the system and methods described in this invention, could coordinate their human resources applications and databases so as to connect to the software governing use of the current invention. By so connecting the two sets of applications, subagents who are dropped from the payroll of the company would automatically have their accounts in the cell phone authorization system terminated. Such a method of coordinating applications is well-known in the prior art. Automated connections between human resources databases and databases that underlie the present invention would guard against the failure of designated agents to manually terminate the cell phone authorization accounts of subagents.

By another aspect of the invention, a retailer's cell phone device could be programmed to require daily time-period registration of each subagent such that the subagent's account would only be active during his period of activity at the retail store. Thus, for example, when a particular subagent goes on duty on any given day, he or she would register by giving a first swipe to the retailer's cell phone authorizing device, entering his or her expected work times for that day, and doing a second swipe to confirm the schedule data entered into the device. Optionally, managerial approval of the schedule data could be required. At the expiration of that subagent's scheduled duty, his or her account status would automatically go inactive, subject to reactivation by simply repeating the daily registration process with a manager's approval by fingerprint swipe and minimal data entry into the cell phone device.

Generally, because of the ease of use and flexibility of cell phone device capabilities, a host of applications and functionality could be programmed into the device to accomplish virtually any goal desired by a particular retailer. As one example of what such a programmed device could accomplish, each transaction between a retail customer and any given subagent could be separately stored in an appropriate sales tracking database for whatever purpose the retail company wishes, including awarding of incentives or bonuses to the subagent. Many such functions could be conveniently built into the device being described here.

By one aspect of this invention, particularly the programmed use of specific series of fingerprint swipes, a secure confirmation and data transmission system for retail and other transactions could optionally be established as follows. At the point of sale, the individual customer would first swipe his or her device and enter his social security number, following which options would be presented on the device's output display. The user would select, for example, which of her credit accounts to use for the purchase. Once the customer had completed her selections, the retail agent or subagent would enter his fingerprint swipe, whereupon the display of the cell phone could optionally ask for confirmation of both the customer's choice of credit account and the retail store's identity. Next, the retail agent or subagent would enter the customary sales data and, when finished with said entry, the subagent would re-swipe to transmit the data and confirm the transaction. The last step in the transaction anticipated by this aspect of the invention is the retail customer's confirmation of the transactional data by entering a second and last swipe of his fingerprint onto the cell phone.

The transactional steps described above are illustrative rather than definitive. Different possible sequences of fingerprint swipes, including, for example, required swipes by a store's manager in the case of very large purchases, could be programmed into the cell phone authorizing system of this invention. A key aspect of the current invention is the design and use of pre-programmed fingerprint swipe sequences entered onto a single device to initiate, conduct, authorize and confirm retail and other transactions. As suggested, when a designated retail agent first authorizes use of the cell phone transactional system by a subagent, a maximum dollar amount of subagent approval authority could optionally be one element of the subagent's account. Then, in the case of a sale exceeding this limit, the cell phone authorization system would require a managerial swipe to complete the authorization process envisioned by this invention.

By another aspect of this invention, users of the system would have the option of entering transactional data directly into the cell phone authorizing device. Optionally, employing technology known in the prior art, for example, use of infrared connectivity, a personal area network, or PAN, could be established between the cell phone and the retailer's electronic device, permitting data to be entered into any ordinary PC or laptop equipped with standard infrared, or other, connectivity. By this aspect of the invention, retail personnel could more conveniently enter and print out transactional data.

By another aspect of this invention, the cell phone device owner could optionally choose to cause transactional data generated by his device to be transmitted to his PC at home. As one aspect of the system and methods described herein, an application could be installed in an individual user's home PC that would establish connectivity to the main databases of the system described herein such that data pertaining to any given individual user could immediately, or within a brief period of time, be transmitted over the Internet to the individual user's own computer. Such an option would provide additional security and descriptive information for the convenience of the credit account user.

By this aspect of the system and methods claimed herein, credit account users could optionally elect to have their monthly statements transmitted directly to their computers at home, eliminating the need for the current system of monthly mailing of credit card bills. All of the individual user's accounts could, under this optional use of the system described herein, appear on a continuous basis on the user's computer, with an automated monthly summary and billing included within the system of this invention.

As another aspect of this invention, medical data could be subjected to special handling by means of the system and methods described in this invention. One part of the optional user's home machine application could include means for entering and storing any medical information that the user wishes to expose to providers of medical services, such a system and methods for handling medical data comprising the sequential entry of fingerprint data as described above in connection with retail transactions conducted according to the present invention. That is, when a device owner wished to display his existing medical records to a health care provider, a series of fingerprint swipes by the device's owner and the provider would coordinate the downloading and display of the medical data, bringing it from the user's home PC to the display of the hand-held device. By infrared means of connecting the mobile device and any nearby electronic device similarly equipped, such a hospital computer, the data could be displayed on the latter device.

As an aspect of this proposed medical data handling system, the privacy of patient information is secured by virtue of the data's residing optionally on the user's home machine rather than in any centralized database. Access by medical professionals to the data, at the user's option, would be by means of Internet connectivity between the user's home PC and the applications and communications means envisioned to be used in the present invention.

Further to this aspect of the invention, medical services providers would be enabled not only to read private data of patients by the means described but also, optionally at the cell phone user's discretion, be enabled to enter data into the user's store of medical information by use of fingerprint swipe authorization and confirmation all as described in connection with retail transactions discussed above. Medical professionals would be required to register accounts in a manner substantially similar to the system and methods described above as part of the current invention for registering retail agents and subagents. For example, a principal hospital manager, designated as that facility's registration agent, would go to a local cell phone service provider's office and engage in a formal, documented registration and identification process that would establish an account for that particular hospital and also at the same time vest authority in the hospital's principal agent to register and authorize appropriate subagents, such as doctors and nurses, to have whatever level of authorization deemed appropriate in the circumstances by the principal agent. As before, no special equipment or devices would be required for a medical facility to participate in this system except for a single cell phone device preprogrammed to accomplish the specified functions.

As a further aspect of this invention, optionally at the user's discretion, the preprogrammed medical application resident on the cell phone authorizing device would include an ‘emergency’ option such that, in case of the unconsciousness or other incapacity of the device's user, a registered medical practitioner could download that patient's medical information by a swipe of only his or her own fingerprint. Since the entire medical data transaction would be stored in a database and subject to review, the danger of misuse by medical services providers would be virtually eliminated, ensuring the use of this method only in genuine emergency conditions. This capacity for a single swipe in emergency circumstances could save lives when, for example, an unconscious patient requires immediate treatment but has a latent allergy to some medication or other substance that would normally be used in the prospective emergency treatment or had some other latent condition that a doctor would need to be aware of prior to resuscitation attempts.

By a related aspect of the current invention's potential use for the handling of medical data, the preprogrammed application could optionally include means for the attending physician or other medical services provider to phone the patient's regular doctor on the spot to obtain whatever information might be required in treatment. As with the description above in connection with use of the present invention for retail transactions, a wide variety of potential medical-related functions could be built into the device-resident application as the need for such functions becomes apparent.

It is another aspect of the present invention that the methods claimed and described above in connection with credit/debit transactions are adaptable to being used in connection with law enforcement. It is envisioned that law enforcement entities such as a city police department, could register a cell phone device by the terms of claim 6, including the method of agent-subagent registration of said claim. In addition to being wirelessly connected to financial transaction or medical information applications and databases, the user's cell phone could optionally be connected to law enforcement databases and applications. When, for example, a device owner is subjected to a traffic or other law enforcement stop, a sequence of fingerprint swipes by the user and by the law enforcement officer could activate the connection and download for display material information about the user, such as her license data, car registration and any other relevant information. The advantage to cell phone owners who enable such law enforcement transactions is that traffic stops would thereby by made quicker and less inconvenient. Instead of the law enforcement officer's having to gather data manually from the user and then return to his patrol car to access a laptop for further processing, the entire transaction could be initiated and completed by the side of the user's car. As well, in the case of emergency roadside assistance involving an unconscious or otherwise disabled user following an accident or sudden illness, the law enforcement officer could be optionally enabled to activate either or both the medical and law enforcement functions of the cell phone to enable more effective emergency assistance.

It is a related aspect of the present invention, under claim 1, that a fingerprint swiping application be programmed into the cell phone device such that when a user swipes a thumbprint onto the device, an emergency 911 call is made from the phone. In some circumstances the saving of even a few seconds, this being the difference between a quick thumb swipe and having to dial 911 on the keypad, could make a difference in the safety or health of the device user. Since it is contemplated by cell phone industry standards that a cell phone device's locator functionality be capable of fixing a user's location within 125 meters, a 911 call from such a device would be able to pinpoint virtually the exact location of the caller. (http://www.fcc.gov/911/enhanced/releases/motaccuracy.pdf)

### DETAILED DESCRIPTION

The invention provides a biometric method exercised over a cell phone or other mobile communications device for engaging in various transactions, such as credit and debit purchases. The key features of the inventions are the integration into the cell phone of all the necessary software and biometric means, the bifurcation of fingerprint or other biometric data and the adaptation of existing databases and related software applications to enable the convenient, low-cost and secure execution of such transactions.

The present cell phone authorization system comprises the following components:

Cell phone (CPh) adapted to perform the functionality required by the present system and methods, it being understood that prior art teaches the technical means necessary to produce a cell phone so designed, including wireless connectivity means Internet, LAN, WAN and PAN, biometric identification solutions and cell phone-based microprocessors, data storage and drives.

These components together allow a buyer or other transactional initiator to originate an electronic payment without requiring use of any other container, such as a credit card, and without requiring the second, payor party to use any special equipment beyond the CPh.

The CPh is enabled to gather identity information for use in authorizing electronic payments, possessing the in-built means to conduct the following functions:

Accept biometric input from the device owner and from authorized second parties

Accept the device owner's social security number

Optionally accept a PIN or password from such parties

Conduct secure communications between the cell phone device and other entities

Maintain in memory encryption keys

Retain in memory the cell phone device's unique serial number

Display data that is obtained both from the device's memory and from networked resources

Manipulate digital biometric data for identification purposes

Allow the owner and authorized second party user to make selections from a list or menu

An embodiment of these components would function as follows:

Fingerprint input is gathered using a sensor located within the CPh operating under control of a microprocessor. The sensor is a finger image sensor, it being an aspect of the present invention that other biometric sensor means could be deployed on the CPh. The user's social security number may be entered on the device keypad, with the proviso that the entire number is never stored, either in the device or on a central database, except for such transient storage required by the microprocessor's comparison of the whole number with the combined parts stored centrally and locally on the device.

The biometrically equipped CPh may also employ biometric fraud detection means guaranteeing that biometric input has been entered by a real physical person and is not replicated or copied biometric data, such fraud detection means preferably being, in the case of a fingerprint scanner, a blood flow detector.

The CPh of this invention may also be configured to accept PIN numbers by means of its keypad and to process the input PIN in the microprocessor.

Techniques well-known in the prior art may be incorporated into and integrated with the system and methods of the present invention to secure communications between the CPh and any other device. Several effective varieties of encryption/decryption methods are well-known to those versed in current information security technology.

Each CPh will bear its own hardware code or serial number affixed at the time and place of manufacture. This will be stored both in CPh memory and in a centralized database, linking a uniquely numbered device with a unique fingerprint, increasing the security of the system and methods disclosed in the present invention.

Transactional data such as dollar amounts and the like can either be entered directly into the CPh by use of its keypad or, in an alternative embodiment, the CPh can use infrared or other short-range connectivity to link wirelessly with a retailer's computer or other electronic device to permit more convenient entry of data on larger equipment.

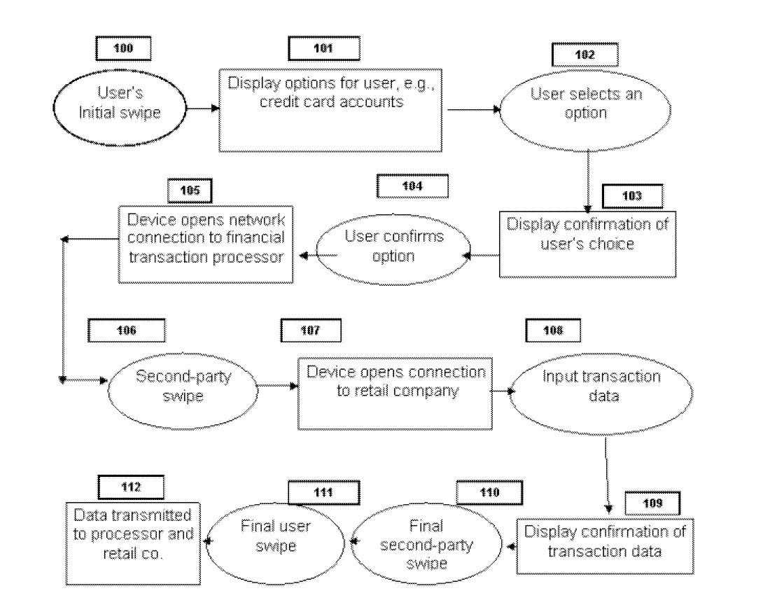

A preferred embodiment of the present invention as shown in FIG. 1 will comprise a series of transactional steps such that, when the cell phone user first swipes his or her fingerprint onto the device 100, the display unit will pose a series of questions pertaining to what kind of transaction the user wishes to begin 101. The user will make a selection 102 and the device display will ask for confirmation 103. After the user confirms 104, a network connection will be opened to, for example, the relevant financial transaction processor 105. In the case of a retail transaction, the retail clerk will swipe her fingerprint onto the device 106 causing the device to open a network connection to the retail company's database application 107. The transactional data will be entered 108 and confirmation will be requested 109. The retail clerk will make a second and last swipe 110 as will the user 111. Following these final authorizing steps, data will be transmitted over the network connections to the financial account processor and the retail company 112.

The entry of data and the network connectivity of the present system and methods is optionally centered upon the cell phone device itself, which may be used to effectuate any transaction envisioned by the present invention without the need for any other equipment. In the alternative, by means of well-known personal area network (PAN) technology, the cell phone and a second nearby device may be used in conjunction with each other at the convenience of the parties to the transaction.

The system and methods of the present invention may also be used to secure online purchases and other similar transactions. The system and methods of the invention may easily be extended by, for example, adding a step to the verification process for online sales requiring the cell phone user engaging in the online transaction to swipe his or her fingerprint on the cell phone device and dial a given telephone number to verify identity. Such an extension of the system and methods herein claimed could help to secure online commerce against identity theft and other frauds.

The present invention makes use of standard, well-known communications paths known as Internet, LAN or WAN. The required network connectivity methods and means that the invention calls for are already well-known in the prior art. By the same token, well-known security precautions such as various methods for the encryption of data may also be used in connection with the system and methods herein described.

It is a principal advantage of the present invention that no additional central databases are required to be established or maintained in order to operate the system and methods described. Each financial transaction processor or other credit-granting establishment can make alterations to its existing installed base of software for the purpose of accommodating transactions that will be conducted under the terms of this invention. Other inventions that have appeared in this field call for the operation of separate data centers to handle, for example, storage of biometric data and verification of identity. Since, however, the present invention does not permit any complete copy of users'biometric data to be stored centrally, there is no danger that a breach of security will lead to identity theft. The only complete copy of such biometric data is stored transiently on the cell phone device during the identification process and is never transmitted over any network nor stored permanently in the cell phone device itself.

It is also an advantage of the present invention that during the course of any transaction envisioned by the claimed systems and methods that the retail clerk or other second party does not view or have access to the first party's account information such as account number or other identifying data. While this information is transmitted securely over networks, it is never displayed.

It is another advantage of the present invention that it makes use of an existing, well-developed infrastructure of cell phone service providers to handle the initial registration of the described cell phone devices. By this aspect, the goals of convenience to prospective users and low-cost set-up and operation of the system are met. Other inventions in this field require investment in new entities to handle the registration aspects of their claimed methods.

The above description discloses the advantages of the present invention:

First, replacing all cards and other containers with an ordinary cell phone eliminates the need to carry cards and the like on a user's person

Second, employing various programmed sequences of fingerprints or other biometric features enhances security in transactions

Third, employing cell phone service providers to do the initial registration of cell phone users results in low cost and convenience

Fourth, permitting second party users, such as retail stores, to use such cell phone service provider offices to do their own registrations further reduces the cost of implementation and increases convenience of use

Fifth, permitting authorized retail agents to in turn register their subagents, such as retail clerks, by means of the issued cell phone device further lowers the cost of implementing the systems and methods of this invention

Sixth, bifurcating biometric data and social security numbers, with the one part centrally stored and the other part kept in the cell phone device eliminates identity theft for those using the described system and methods

Seventh, integrating the present invention with existing online purchase methods may reduce online fraud

Eighth, not requiring the establishment of any new centralized databases beyond those already maintained by credit card companies or their financial transaction processors greatly reduces the cost of deploying the invention

Ninth, the invention enables an automated, convenient and efficient means to transmit and receive private medical data including use in emergency situations

Tenth, the invention enables an automated, convenient and efficient means to transmit and receive data such as traffic, license and vehicle records for law enforcement purposes

Although the invention has been described with respect to a transactional system based on use of a mobile electronic communications device, it will be appreciated that various modifications of the system and methods claimed are possible without departing from the invention, as defined by the claims set forth above.

What is claimed is:

1. a system and methods for using specified sequences of fingerprints, or other biometric identification means, together with a cell phone, or other such mobile communications device, wherein a biometric sensor is made part of the device and wherein the device's computer contains resident applications that read the sequence of fingerprints and respond by making available to the users of such devices the communications and data storage capacities of such device.

2. a system and methods under claim 1 for enabling transactions between the device's owner and any authorized second party wherein both parties use only the cell phone device to input data and connect to other applications and wherein no resort is had to any other device or equipment to conduct the transaction except insofar as the parties may optionally network the device with a second device for convenience or efficiency.

3. a system and methods for splitting and storing digital representations of biometric identification, such as a fingerprint, wherein the one part of the digital data is stored in the memory of the user's device described in claim 1 and the other part is stored in a network-accessible database, together with methods to programmatically access each part of the said digital representation and to combine such parts for the purpose of confirming a user's identity, such confirmation being made on the user's device by means of software applications resident in the memory of the device.

4. a system and methods for splitting and storing a social security number wherein the one part of the number is stored in the memory of the user's device described in claim 1 and the other part is stored in a network-accessible database, together with methods to programmatically access each part of the said social security number and to combine such parts for the purpose of confirming a user's identity, such confirmation being made on the user's device by means of software applications resident in the memory of the device.

5. a system and methods for creating, maintaining and confirming identities of users of a mobile electronic device wherein users will undergo an initial authorization, identification and registration process at an appropriate location and wherein as a result of such process the mobile device will be able to recognize the fingerprint of the user of the device in connection with credit card and debit card transactions and in connection with other uses.

6. a system and methods for creating, maintaining and confirming identities of second party users of a mobile electronic device wherein those who will engage in transactions with the device user, such as retail store clerks, will undergo an initial authorization, identification and registration process conducted by means of the retail company's own mobile device, wherein as a result the device of the retail customer will be able to recognize the fingerprint of any authorized retail seller or seller's agent and wherein a similar result is achieved with respect to the other uses of the methods of this invention, including use in connection with law enforcement and health care services.

7. a system and methods for privatizing the storage of sensitive user information like medical data wherein the user's home computer is enabled by resident software applications to hold such information and be connected to devices, databases or other applications according to the user's directions entered into the user's mobile device and wherein a medical services provider authorized according to the terms of claim 6 may view the user's medical data and may input additional information by using the cell phone's display and input means.

8. a system and methods for using a cell phone or other similar mobile electronic communications device to enable certain law enforcement transactions wherein by a sequence of fingerprints or other biometrically identifying inputs the user's device is connected by network connectivity means to a law enforcement or vehicle registration database, wherein the user's data from such database may be displayed on the device and wherein a law enforcement officer may view such data and enter further relevant data by using the cell phone input means.
